(19) United States
(12) Patent Application Publication
(10) Pub. No.: US 2010/0122617 A1
(43) Pub. Date: May 20, 2010

(54) Dicing machine and adapter for dicing machine

(75) Inventor: Nobuyuki Mori, Kumamoto (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/591,294

(22) Filed: Nov. 16, 2009

(30) Foreign Application Priority Data
Nov. 18, 2008 (JP) 2008-294750

(51) Int. Cl. B26D 1/14

(52) U.S. Cl. 83/491

(57) ABSTRACT

The dicing machine includes a rotary blade with a rotating shaft, applicable to processing a work, and a disk-shaped presser rotatably supported by the rotating shaft on a side of the blade, so as to roll on an upper face of the work independently from the blade.

This application is based on Japanese patent application No. 2008-294750, the content of which is incorporated hereinto by reference.

### BACKGROUND

1. Technical Field

The present invention relates to a dicing machine and an adapter for the dicing machine.

2. Related Art

JP-A No. 2004-186635 and JP-A No. 2003-218064 disclose a dicing machine in which a blade and a presser that presses a work are mounted independently from each other.

A dicing machine according to JP-A No. H05-77105 includes a presser located adjacent to a lateral face of a roll cutter and supported coaxially with a rotary blade. The presser rotates in combination with the roll cutter which cuts a work.

Further, JP-U No. H05-63051 discloses a dicing machine that cuts and divides a semiconductor wafer 3 including bump 4 electrodes into individual chips. Referring to FIGS. 6A and 6B, this dicing machine will be described further.

FIGS. 6A and 6B show the dicing machine based on a related art. The dicing machine includes a dicer 5, and a rubber roller 6 that presses the bump electrodes 4 located on the respective sides of the position to be cut by the dicer 5. In this dicing machine, the dicer 5 and the rubber roller 6 are supported by different rotating shafts. Accordingly, the relative position between the dicer 5 and the rubber roller 6 is prone to fluctuate, in this dicing machine. The fluctuation of the relative position between the dicer 5 and the rubber roller 6 may provoke a damage on the work surface by the rubber roller 6, and deviation of the position to be cut by the dicer 5. Therefore, the relative position from the blade to the rubber roller 6 has to be adjusted with high precision.

Meanwhile, in the case of a dicing machine without a presser, fine vibration generated in the cutting process cannot be suppressed, and hence a cut facet of the wafer may suffer chipping.

With the dicing machine according to JP-U No. H05-63051, the fluctuation of the relative position between the dicer 5 and the rubber roller 6 may provoke a damage on the work surface by the rubber roller 6, and a positional shift of the position to be cut by the dicer 5. Also, regarding the dicing machine without a presser, fine vibration generated in the cutting process cannot be suppressed, and hence a cut facet of the wafer may suffer chipping.

### SUMMARY

In one embodiment, there is provided a dicing machine comprising a rotary blade with a rotating shaft, applicable to processing a work; and

a disk-shaped presser rotatably supported by the rotating shaft on a side of the blade, so as to roll on an upper face of the work independently from the blade.

In the dicing machine thus constructed, the blade and the disk-shaped presser are supported by the same rotating shaft, and hence the relative position between the blade and the disk-shaped presser is restricted from fluctuating. Such configuration assures that the disk-shaped presser effectively presses the work by rolling on the upper face of the work, while the blade is processing the work.

The structure that the blade and the disk-shaped presser are supported by the same rotating shaft prevents a damage on the surface of the work by the disk-shaped presser and restricts a deviation of the position to be processed by the blade, as well as the chipping on the cut facet of the work.

### BRIEF DESCRIPTION OF THE DRAWINGS

The above and other objects, advantages and features of the present invention will be more apparent from the following description taken in conjunction with the accompanying drawings, in which:

FIG. 1 is a cross-sectional front view of a dicing machine according to an embodiment of the present invention;

FIG. 2 is a fragmentary side view of the dicing machine according to the embodiment;

FIG. 3 is a fragmentary side view of a variation of the dicing machine according to the embodiment;

FIG. 4 is a schematic cross-sectional side view of a conventional dicing machine;

FIG. 5 is a schematic front view of the dicing machine of the related art; and

FIGS. 6A and 6B are a front view and a plan view respectively, showing the dicing machine of the related art.

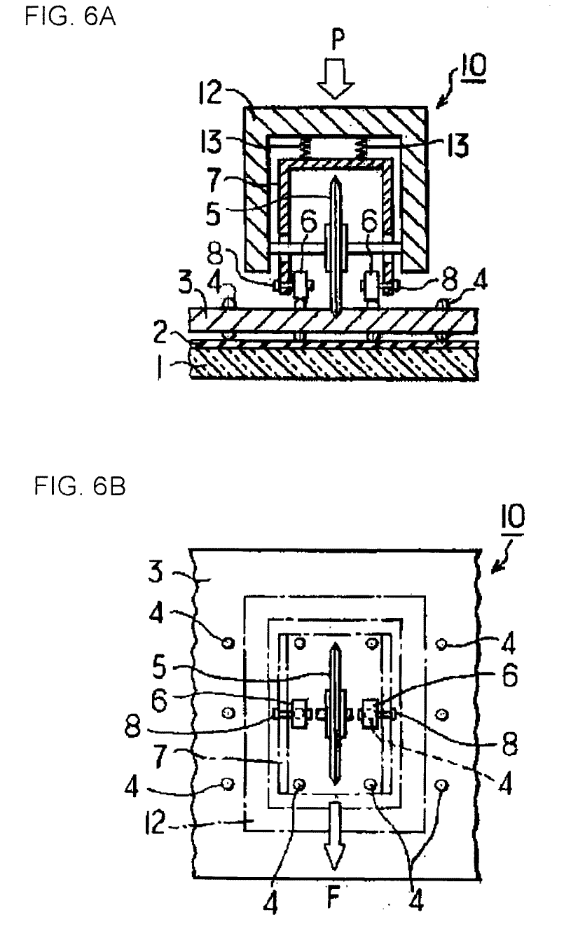

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

An embodiment of the present invention will be described hereunder, referring to the drawings. Constituents of the embodiment will be given the same denomination, and detailed description thereof will not be repeated.

Also, back and forth, left and right, and up and downward directions will be referred to in this embodiment for description based on the drawings. Such description should be construed to be adopted for the sake of convenience in explaining the relative position of the constituents, without the intention to limit the actual direction in the manufacturing process of the product in which the present invention is incorporated, or in the use thereof.

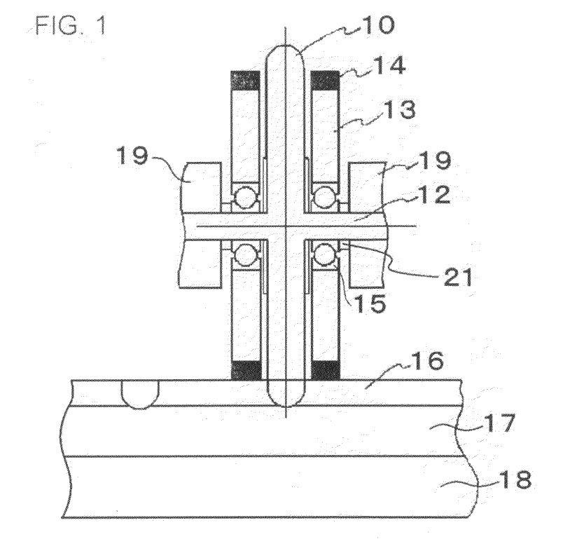

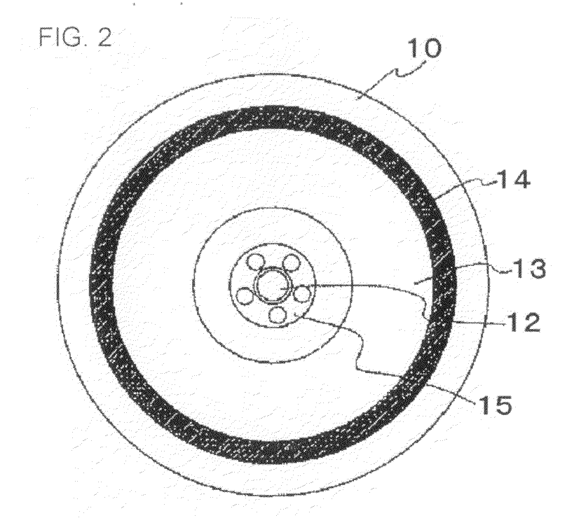

FIGS. 1 and 2 illustrate a blade of a dicing machine according to an embodiment of the present invention.

The dicing machine includes a rotary blade 10 with a rotating shaft 12 for processing a work (wafer 16), and a pair of disk-shaped pressers rotatably supported by the rotating shaft 12 on the respective sides of the blade 10, so as to roll on the upper face of the wafer 16 independently from the blade 10.

In the dicing machine according to this embodiment, the disk-shaped presser includes a rotating plate 13 rotatably supported by the rotating shaft 12, and may further include an elastic portion 14 (such as urethane rubber) on the circumferential surface of the rotating plate 13, to thereby press the upper face of the wafer 16.

The blade 10 rotates interlocked with the rotation of the rotating shaft 12. Accordingly, the blade 10 may be integrally formed with the rotating shaft 12, as shown in FIGS. 1 and 2. Otherwise, the blade 10 may be fixed to the rotating shaft 12 by means of a mounting mechanism 19. In this case, the blade 10 may be mounted on the dicing machine (not shown) via the rotating shaft 12, by means of the mounting mechanism 19.

To the rotating shaft 12 rotatably supports a pair of disk-shaped pressers attached on the respective sides of the blade 10.

As shown in FIG. 2, the disk-shaped presser includes the rotating plate 13. The rotating plate 13 is rotatably supported by the rotating shaft 12 via a bearing.

The type of the bearing is not specifically limited as long as the rotating plate 13 is rotatably supported by the rotating shaft 12 in a practically operable manner. For example, a ball bearing 15 may be employed. With such bearing, the rotating plate 13 can stably and smoothly rotate with respect to the rotating shaft 12. The dicing machine according to this embodiment may also include a fixing mechanism (stopper 21) that presses the ball bearing 15 against the blade 10, to thereby fix the rotating plate 13 to the rotating shaft 12.

It is because the disk-shaped presser is rotatably supported by the rotating shaft 12, that the rotatably disk-shaped presser can roll on the upper surface of the wafer 16 independently from the blade 10. Under such structure, the disk-shaped presser can freely rotate while the rotating shaft 12 is rotating driven by a driving mechanism (not shown) of the dicing machine. Accordingly, while processing the wafer 16, the disk-shaped presser rolls on the surface of the work according to the movement thereof, independently from the rotation of the blade 10 interlocked with the rotation of the rotating shaft 12.

Hereunder, description will be given on the processing of the wafer 16 with the dicing machine according to this embodiment.

As shown in FIG. 1, the wafer 16 is fixed on a flat table 18 to be processed by the dicing machine. The method of fixing the wafer 16 on the flat table 18 is not specifically limited. For example a UV sheet 17, having such character that the adhesion performance is degraded by UV irradiation, may be employed to fix the wafer 16 on the flat table 18.

Then the flat table 18 moves at a constant speed, while the blade is rotated at a high speed to thereby process the wafer 16. The processing method is not specifically limited, and can be exemplified by half cut, semi-full cut, step cut, hebel cut and so forth.

Now, in the dicing machine according to this embodiment, since the blade 10 and the disk-shaped presser are supported by the same rotating shaft 12, fluctuation of the relative position between the blade 10 and the disk-shaped presser is restricted.

Accordingly, while the blade 10 is processing the wafer 16, the disk-shaped presser securely presses the wafer 16, on the region on the respective sides of the portion being processed. Also, the disk-shaped presser rolls on the wafer 16 in contact with the surface thereof in the same moving direction as the blade 10, and presses the chips on the respective sides of the cutting line, while the blade 10 is processing the wafer 16.

Such arrangement allows preventing a damage on the surface of the wafer 16 by the disk-shaped presser, and restricting fluctuation of the cutting position of the blade 10.

Also, during the processing of the wafer 16, the disk-shaped presser serves to press the wafer 16 on the portion on both sides of the cutting line of the blade 10, and thereby mitigates the shearing stress incurred in the wafer 16. Therefore, in this embodiment the chipping, which may occur immediately after the cutting the wafer into individual chips, can be restricted.

As already stated, since the blade 10 and the disk-shaped presser are supported by the same rotating shaft 12, the blade 10 and the disk-shaped presser roll on the wafer 16 in the same moving direction. Also, since the disk-shaped presser is rotatable with respect to the rotating shaft 12, the disk-shaped presser rotates at the same speed as the moving speed of the wafer 16, while pressing the wafer 16.

In this embodiment, therefore, the wafer 16 can be prevented from suffering a damage on its surface because of rotational friction with the disk-shaped presser.

Hereunder, description will be given on an adapter for the dicing machine according to the embodiment of the present invention.

The adapter to be used with the dicing machine according to this embodiment includes the rotary blade 10 with the rotating shaft 12 for processing a work, and a pair of disk-shaped pressers rotatably supported by the rotating shaft 12 on the respective sides of the blade 10, so as to roll on the upper face of the work independently from the blade 10.

As shown in FIG. 1, the adapter for the dicing machine includes the pair of disk-shaped pressers located on the respective sides of the blade 10, and supported by the same rotating shaft 12 of the blade 10. The rotating plate 13 of the disk-shaped presser includes the ball bearing 15. The adapter for the dicing machine further includes a fixing mechanism (stopper 21) that presses the ball bearing 15 against the blade 10, to thereby fix the rotating plate 13 to the rotating shaft 12.

The stopper 21 presses, for example, the right side of the ball bearing 15 so that the left side thereof is pressed against the right face of the blade 10, to thereby fix the rotating plate 13 to the rotating shaft 12. In the case where the stopper 21 is of a ring shape, the ring-shaped stopper 21 is supported by the rotating shaft 12, and also serves to fix the rotating plate 13 to the rotating shaft 12. The stopper 21 thus serves to unify the rotating plate 13 with the rotating shaft 12 of the blade 10.

During the processing of the wafer 16, as already stated, the disk-shaped presser rotates at the same speed as the moving speed of the wafer 16 independently from the high-speed rotation of the blade 10, since the disk-shaped presser is rotatably supported by the rotating shaft 12 via the ball bearing 15.

Also, in the adapter for the dicing machine according to this embodiment, the blade 10 and the disk-shaped presser are supported by the same rotating shaft 12, and hence fluctuation of the relative position between the blade 10 and the disk-shaped presser can be restricted.

Such arrangement allows preventing a damage on the surface of the work by the disk-shaped presser, and restricting fluctuation of the cutting position of the blade 10.

The adapter is mounted on the dicing machine (not shown) via the rotating shaft 12, by means of the mounting mechanism 19. The dicing machine may be one of the conventional products.

Employing the adapter for the dicing machine according to this embodiment allows replacing both the disk-shaped presser and the blade 10, at the time of replacing the blade 10.

Further, the rotating plate 13 is provided with an elastic portion 14 (such as urethane rubber) on the circumference thereof, for pressing the upper face of the wafer 16. Accordingly, since the elastic portion 14 provided on the rotating plate 13 serves to press the respective sides of the cutting line of the wafer 16, vibration during the processing can be suppressed.

In this embodiment, therefore, the chipping which may occur immediately after the cutting the wafer into individual chips can be more effectively restricted, compared with the disk-shaped presser without the elastic portion 14.

The material for the elastic portion 14 is not specifically limited, as long as the material has sufficient elasticity to suppress the vibration generated during the processing. It is preferable that the elastic portion 14 has high mechanical strength. It is also preferable to determine the thickness of the elastic portion 14, corresponding to the distance between the circumferential surface of the rotating plate 13 and the surface of the work, according to the hardness of the elastic material. The method of fixing the elastic portion 14 to the rotating plate 13 is not specifically limited.

In this embodiment, for example urethane rubber may be employed as the elastic portion 14, because of its high mechanical strength. In this case, it is preferable that the material is free from siloxane, from the viewpoint of prevention of contamination of the wafer surface.

Meanwhile, in the case of the dicing machine according to JP-A No. 2004-186635 or JP-A No. 2003-218064, the blade and the presser for pressing the work are independently mounted. The presser moves pressing the work, while the blade rotates to cut the work irrespectively.

Accordingly, the work is prone to be damaged because of the friction between the work surface and the presser.

In contrast, in this embodiment the blade 10 and the disk-shaped presser are supported by the same rotating shaft 12, and hence fluctuation of the relative position between the blade 10 and the disk-shaped presser can be prevented. Such structure assures that the disk-shaped presser effectively presses the region on the respective sides of the portion to be cut, while the blade 10 is processing the wafer 16.

Consequently, the work can be prevented from suffering a damage on its surface by the disk-shaped presser, and the cutting position of the blade 10 can be restricted from fluctuating.

In the case of the dicing machine according to JP-A No. H05-77105, the presser is located adjacent to the lateral face of the roll cutter, and supported coaxially with the rotary blade. The presser rotates in combination with the roll cutter which cuts the work.

Such structure has the drawback that the surface of the work may be damaged because of the friction between the work surface and the presser rotating at a high speed.

In contrast, in this embodiment the blade 10 and the disk-shaped presser are supported by the same rotating shaft 12, and hence fluctuation of the relative position between the blade 10 and the disk-shaped presser can be prevented. Such structure assures that the disk-shaped presser effectively presses the region on the respective sides of the portion to be cut, while the blade 10 is processing the wafer 16. Consequently, the work can be prevented from suffering a damage on its surface by the disk-shaped presser, and the cutting position of the blade 10 can be restricted from fluctuating.

Referring further to the dicing machine according to JP-U No. H05-63051, the rubber roller 6 supported by the rotating shaft different from the one for the dicer 5 serves to press the bump electrodes 4 located on the respective sides of the portion to be cut by the dicer 5.

In this case, the rubber roller 6 is required to press the chips of 2.0 mm or smaller, and hence the position of the rubber roller has to be accurately adjusted at several hundred microns from the blade. Besides, for the chips of different thicknesses, the rubber roller 6 has to be replaced for the respective cases to change the height of the roller, which makes the process quite complicated.

In contrast, this embodiment the disk-shaped presser rotatably supported by the same rotating shaft 12 supporting the blade 10. Such structure enables more accurately adjusting the position of the disk-shaped presser. In this embodiment, further, disk-shaped presser can be easily replaced through a single step, even when the chip thickness is different.

In the case of a popular dicing machine, the blade 10 is supported by the rotating shaft 12 by means of a support member 11. To start the processing, the rotating shaft 12 is made to rotate by a driving mechanism (not shown) of the dicing machine, so that the blade 10 rotates.

With such popular dicing machine, the wafer 16 is processed as described below.

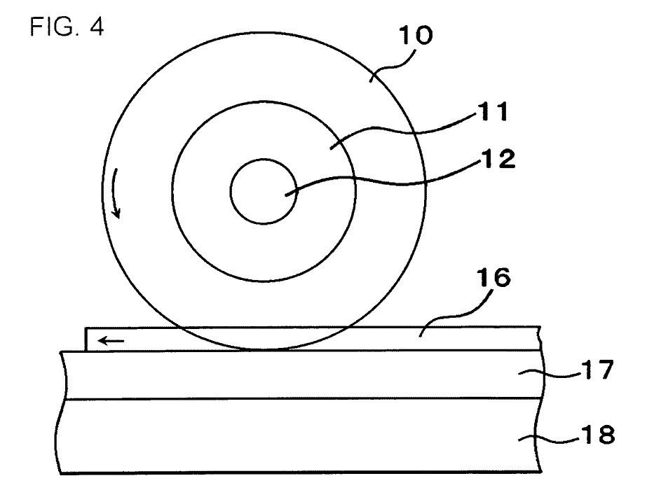

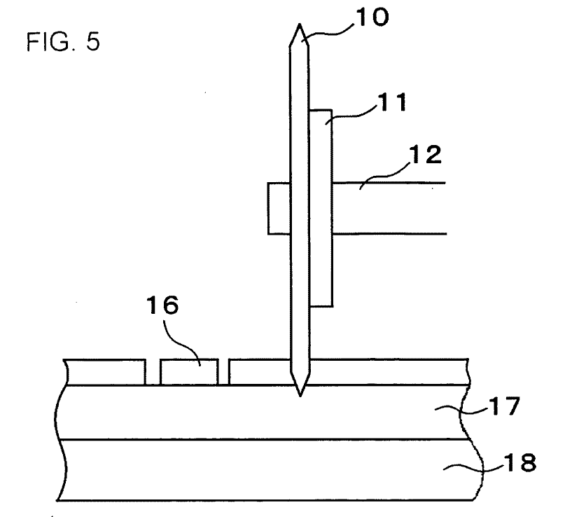

The wafer 16 is set on the dicing machine as shown in FIGS. 4 and 5. The wafer 16 is fixed on the flat table 18 with the UV sheet 17.

Then the flat table 18 moves at a constant speed, while the blade 10 rotates at a high speed, to thereby process the wafer 16. In this process, the blade 10 which is vibrating contacts the wafer 16 immediately after starting the cutting. Since the UV sheet 17 is soft, the wafer 16 is susceptible to the stress imposed by the blade 10 immediately after the start of the cutting. This often results in a defect such as cracking of the wafer 16.

In this embodiment, on the other hand, the blade 10 and the disk-shaped presser are supported by the same rotating shaft 12, and hence fluctuation of the relative position between the blade 10 and the disk-shaped presser can be restricted. Such structure assures that the disk-shaped presser effectively presses the region on the respective sides of the portion to be cut, while the blade 10 is processing the wafer 16. Consequently, the work can be prevented from suffering a damage on its surface by the disk-shaped presser, and the cutting position of the blade 10 can be restricted from fluctuating.

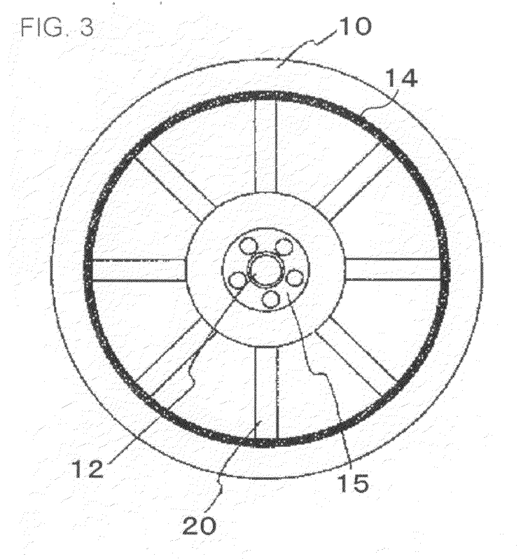

The present invention is not limited to the foregoing embodiment, but various modifications may be made. For example, in the dicing machine according to this embodiment, a rotating plate (wheel-shaped rotating plate 20) may include an opening formed therethrough from the face opposing the blade 10 to the opposite face, as shown in FIG. 3.

The opening provided throughout the rotating plate allows discharging water deposited on the rotating plate in a cleaning process, from the blade 10 toward outside of the rotating plate 13. Accordingly, the residue produced through the cutting process can be more effectively removed by the flowing water, and kept from depositing on the blade or rotating plate.

Also, the opening on the rotating plate may be arranged in a point symmetrical pattern with respect to the rotating shaft 12. Such configuration enables more efficiently discharging the water deposited on the rotating plate.

Accordingly, the residue produced through the cutting process can be more effectively removed by the flowing water, and kept from depositing on the blade or rotating plate. Such rotating plate with the opening can be exemplified by the wheel-shaped rotating plate 20 shown in FIG. 3.

Naturally, the foregoing embodiment and the plurality of variations thereof may be combined as long as the ideas are not contradictory. Although the structure of each part in the embodiment and the variations is specifically described, such structure may be modified in various manners as far as the functions according to the present invention are satisfied.

It is apparent that the present invention is not limited to the above embodiment, and may be modified and changed without departing from the scope and spirit of the invention.

What is claimed is:

1. A dicing machine comprising a rotary blade with a rotating shaft, applicable to processing a work; and
a disk-shaped presser rotatably supported by said rotating shaft on a side of said blade, so as to roll on an upper face of said work independently from said blade.

2. The dicing machine according to claim 1,
wherein said disk-shaped presser includes a rotating plate rotatably supported by said rotating shaft, and
an elastic portion attached to a circumferential surface of said rotating plate, so as to press said upper face of said work.

3. The dicing machine according to claim 2,
wherein said rotating plate includes an opening formed therethrough from a face opposing said blade to an opposite face.

4. The dicing machine according to claim 3,
wherein said opening is arranged on said rotating plate in a point symmetrical pattern with respect to said rotating shaft.

5. An adapter for a dicing machine, comprising a rotary blade with a rotating shaft, applicable to processing a work; and
a disk-shaped presser rotatably supported by said rotating shaft on a side of said blade, so as to roll on an upper face of said work independently from said blade.
